(19) United States
(12) Patent Application Publication
(10) Pub. No.: US 2024/0107312 A1
(43) Pub. Date: Mar. 28, 2024

(54) READER INITIATED PROVISIONING

(71) Applicant: Apple Inc., Cupertino, CA (US)

(72) Inventors: David E. Brudnicki, Duvall, WA (US); Christopher Sharp, Morgan Hill, CA (US)

(73) Assignee: Apple Inc., Cupertino, CA (US)

(21) Appl. No.: 18/372,018

(22) Filed: Sep. 22, 2023

Related U.S. Application Data
(60) Provisional application No. 63/409,674, filed on Sep. 23, 2022.

(51) Int. Cl. H04W 12/08; H04W 12/63; H04W 76/10

(52) U.S. Cl. CPC H04W 12/08; H04W 12/63; H04W 76/10

(57) ABSTRACT

Techniques are described herein for reader initiated provisioning. An example method includes a device detecting a trigger to establish a connection with a second device. The device can receive a first input to verify an identity associated with the second computing device. The device receives from the second device, a first information item comprising identification information based at least in part on the first input. The device receives a comparison result from a server. The device receives a second input to provision a digital access asset onto the second device based on the comparison result. The device transmits, to the second device, the digital access asset based at least in part on the second input.

### CROSS-REFERENCE TO RELATED APPLICATIONS

This application claims priority under 35 U.S.C. § 119(e) to U.S. Provisional Application No. 63/409,674, filed on Sep. 23, 2022, the contents of which are herein incorporated by reference.

### BACKGROUND

Wireless communications enable users to exchange information without any physical device inter-connection. The information exchange can be in a secure and efficient manner. A set of computing devices can be connected using a wireless network that enables the device to communicate over radio transmissions across designated frequency ranges.

### BRIEF DESCRIPTION OF THE DRAWINGS

FIG. 1 is an illustration of an example process for reader initiated provisioning, according to one or more embodiments.

FIG. 2 is an illustration of an example process for reader initiated provisioning, according to one or more embodiments.

FIG. 3 is an illustration of an example process for reader initiated provisioning, according to one or more embodiments.

FIG. 4 is an illustration of an example process for reader initiated provisioning, according to one or more embodiments.

FIG. 5 is an illustration of an example process for reader initiated provisioning, according to one or more embodiments.

FIG. 6 is an illustration of an example process for reader initiated provisioning, according to one or more embodiments.

FIG. 7 is an illustration of an example process for reader initiated provisioning, according to one or more embodiments.

FIG. 8 is an illustration of an example process for reader initiated provisioning, according to one or more embodiments.

FIG. 9 is an illustration of an example process for reader initiated provisioning, according to one or more embodiments.

FIG. 10 is an illustration of an example process for reader initiated provisioning, according to one or more embodiments.

FIG. 11 is an illustration of an example process for reader initiated provisioning, according to one or more embodiments.

FIG. 12 is an illustration of an example process for reader initiated provisioning, according to one or more embodiments.

FIG. 13 is an illustration of an example process for reader initiated provisioning, according to one or more embodiments.

FIG. 14 is an illustration of an example process for reader initiated provisioning, according to one or more embodiments.

FIG. 15 is an illustration of a car with reader initiated provisioning functionality, according to one or more embodiment.

FIG. 16 is an illustration of an example process for reader initiated provisioning, according to one or more embodiments.

FIG. 17 is an illustration of an example process for reader initiated provisioning, according to one or more embodiments.

FIG. 18 is an illustration of an example process for reader initiated provisioning, according to one or more embodiments.

FIG. 19 is an illustration of an example process for reader initiated provisioning, according to one or more embodiments.

FIG. 20 is an illustration of an example process for reader initiated provisioning, according to one or more embodiments.

FIG. 21 is an illustration of an example process for reader initiated provisioning, according to one or more embodiments.

FIG. 22 is an illustration of an example process for reader initiated provisioning, according to one or more embodiments.

FIG. 23 is an illustration of an example process for reader initiated provisioning, according to one or more embodiments.

FIG. 24 is an illustration of an example process for reader initiated provisioning, according to one or more embodiments.

FIG. 25 is an illustration of a process flow for reader initiated provisioning, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

In today's connected world, users demand digital solutions to enhance the efficiency and quality of their daily lives. For example, to reduce wait times, many enterprises have shifted from in-person clerks to digital kiosks and virtual assistants. Users no longer need to interact with a person, and rather can interact with an enterprise through their mobile devices. Even with these advances in technology, digital interaction services must be configured to establish a secure connection, digitally verify an identity, and provide a service. In many instances, enterprises have approached these issues by asking users to download an application on their devices, such as a smartphone, laptop, or wearable device. The enterprise can communicate with a user through the downloaded application.

In some examples, applications may rely on more and more complex source code and may need more memory to operate. This situation can be exacerbated by the fact that each enterprise wants their own application downloaded on a user's devices. As user devices become more and more inundated with third party proprietary applications, the devices can experience more and more applications competing for processing capability and memory. In addition, in many instances, a third-party may provision an asset on the user's device via the third party application. Furthermore, the user may be unable to enjoy some product or service without the provisioned application. This further increases the user's need to download multiple third party applications onto their devices, as they cannot enjoy the products and services without the provided asset.

Embodiments herein address the above-referenced issues by providing techniques for a user device to securely initiate a secure communication session with a third party device without a third party application downloaded on the user device. During the secure session, the user device can present a user identification to the third party device. The third party device can verify the identification through a verification application programming interface (API). Once the user identity can be verified, the user can communicate with the third party through their device and request that an asset be provisioned on their device. The third party device can retrieve the asset from a third party server and provision the asset onto the user device.

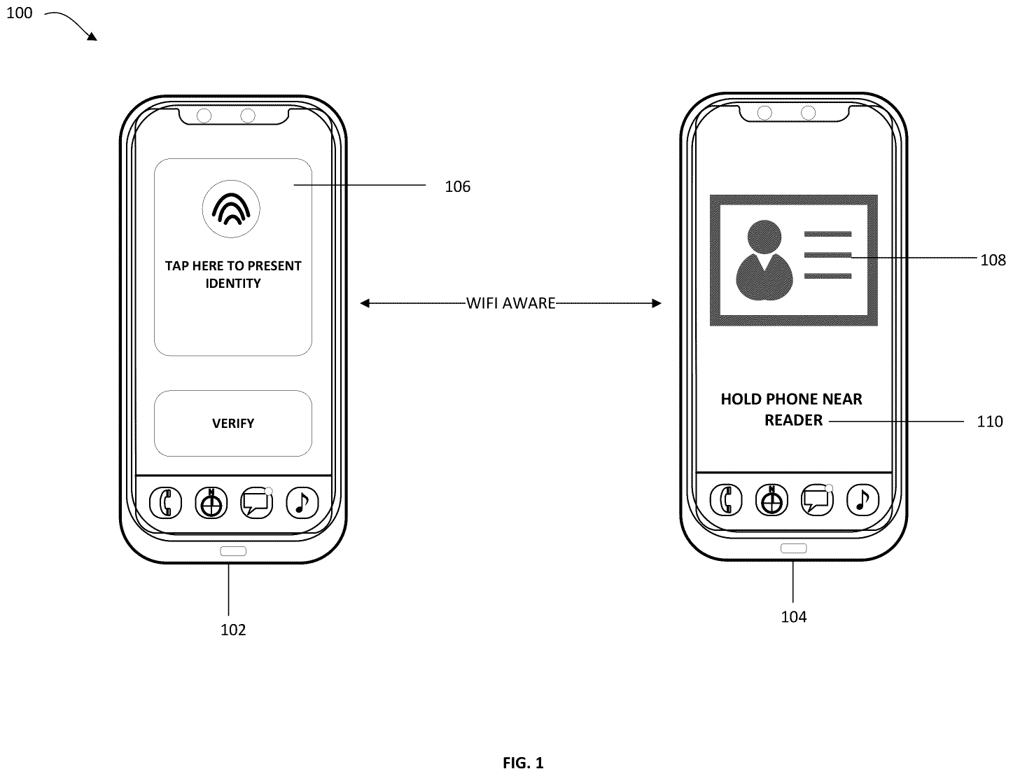

FIG. 1 is an illustration 100 of an example process for reader initiated provisioning, according to one or more embodiments. A reader device 102 and a user device 104 are illustrated. A reader device can be any device (e.g., smartphone, laptop, kiosk, point of sale device, tablet, etc.) capable of executing a wireless protocol to communicate with the user device 104. For example, the reader device 102 can include an integrated circuit (e.g., near field communication (NFC), radio frequency identification (RFID), Bluetooth) for wirelessly communicating with the user device 104 over a short range. The reader device can be a device that a third party has arranged to provision an asset to a user through the user device 104. As illustrated, the reader device 102 has been arranged to provision a digital hotel key for the user. It should be appreciated that the illustrated method can be used for a variety of third party services that provision an asset on a user device, and without necessarily having a third party application executing on the device.

A user can approach the reader device 102 with their user device 104 while both devices are powered on. In the instances that the reader device 102 and the user device 104 become within a threshold range (e.g., four inches) of each other, The reader device 102 can provide the user device 104 with a first information item. The first information item can be information that can be used by the user device 104 to identify the reader device 102. The first information item can include, for example, a unique device identifier (UDID), an international mobile equipment identity (IMEI), a media access control (MAC) address, or other appropriate device identifier. The devices can establish a secure connection with each other, in which sensitive data can be encrypted for in flight transmission. For example, both devices can be active NFC devices that operate in a peer-to-peer-mode, in which the devices are active when transmitting and passive when receiving.

As described above, the triggering condition for establishing the secure connection is the devices being in a proximity of each other. In other instances, the reader device 102 and the user device 104 can establish a secure connection based on other triggering conditions. For example, the user device 104 can display a visual maker, such as a QR code, or bar code. The reader device 102 can scan the visual marker and initiate establishing the secure connection. In other instances, a user can present a credential, such as a driver's license. The credential can be physical credential that the reader device 102 can scan, and use image processing to validate. The credential can also be an electronic credential, that can be access by the reader device 102 and validated. In other instances, the triggering condition can be an input. For example, the entity managing the reader device 102 can enter an input commanding the reader device 102 to initiate establishing a secure connection.

In response to establishing a secure connection, the reader device 102 can display presentation prompt 106. For example, as illustrated, the presentation prompt 106 can read “tap here to present identity”. In addition, the user device 104 can display an identity 108 and instructions to hold the user device 104 near the reader device 102. The user device 104 can store one or more information items that can be used to identify the user. For example, a first information item can include a user's name, photographs, physical address, email address, telephone number, credit card information, social media profile or other appropriate identifying information. The user can take the user device and tap the display side against the reader device 102. The reader device 102 can include a verification application programming interface (API) for receiving identification data and verifying the identity of the user's device's owner. For example, the user can have previously reserved a room at the hotel through an online service. During the reservation process, the user can have provided various information items to complete the reservation process. However, it should be appreciated that these information items are based on information items requested by the third party. Therefore, this set of information items can include a subset of the information items stored on a user device. For example, a user may store all information on all credit cards on the user device. However, the information items provided during the reservation process can include a single credit card. A second information item can include a name, image, address, credit card number. This information can be stored at a third party server (e.g., hotel server) that can be in operable connection with the reader device 102. The verification API can collect identification information from the user device 104 to verify the identity through the third party server. The server can compare the first information item (e.g., user identifying information stored on the user device) to a second information item (e.g., a subset of such identifying information, which may be stored on the third party server) to authenticate and/or verify the user's identity. For example, the name, credit card information, and address of the user entered at the time of reservation can be compared to the personal identification information presented through the user device 104 identity service.

In some embodiments, the reader device 102 and the user device 104 can be WiFi aware, also known as neighbor aware networking (NAN). WiFi Aware can be a technology that can enable reader device 102 and the user device 104 to discover each other and connect directly without each other without another type of connectivity between them.

WiFi Aware can be a hardware and software technology that operates by forming clusters with neighboring devices, or by creating a new cluster if the device is the first one in an area. The WiFi clustering can be controlled by a device and applications that are executing on the device cannot exert control over the process. The applications (e.g., a reader service on the reader device 102 and an identity service on the user device 104) can use WiFi Aware APIs to talk to a WiFi Aware system service, which can manage the WiFi Aware system on the device.

The APIs can permit the application to discover other devices. For example, a hotel check and key provisioning service can discover user devices that need keys provisioned. An API can have a mechanism for detecting nearby devices. For example, a third part device (e.g., reader device) can publish one or more discoverable services (hotel check in and key provisioning service). Then, the user device 104 can move within range of the reader device 102 to discover the reader device 102. The user device 104 can then transmit a message to the reader device 102 or establish a secure connection with the reader device 102.

Once the reader device 102 and the user device 104 have discovered each other the devices can create a bi-directional WiFi Aware network connection without an access point (AP) (e.g., router).

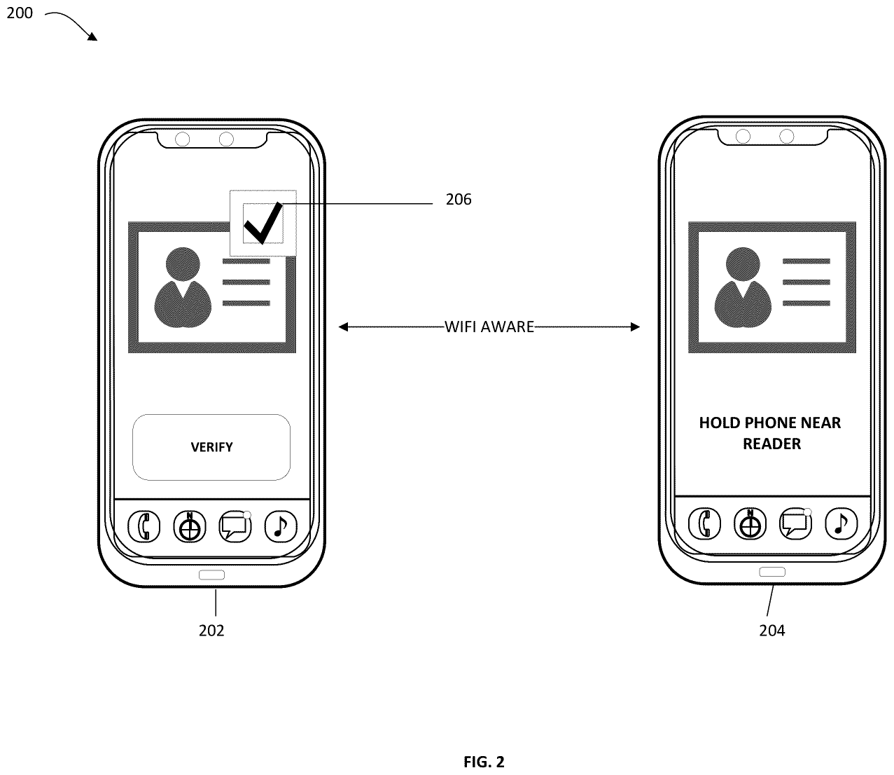

FIG. 2 is an illustration 200 of an example process for reader initiated provisioning, according to one or more embodiments. In particular, FIG. 2 can relate to verifying an identity of a user of a user device. A reader device 202 and a user device 204 are illustrated, which can be the same as the reader device 102 and the user device 104 of FIG. 1. In response to verifying the identity, the reader device can display a visual icon 206 indicating the verification. As illustrated, the visual icon 206 can be a check mark. In this sense, the user of the user device 204 can see that the identification verification was successful. In the event that the identification verification was unsuccessful another visual icon could be displayed, such as an “x” to indicate that the verification was unsuccessful. In the event the identification is unsuccessful, the user can retry identification verification. The user device 204 and the reader device 204 can remain in a WiFi Aware state while the reader device 202 is presenting the visual icon.

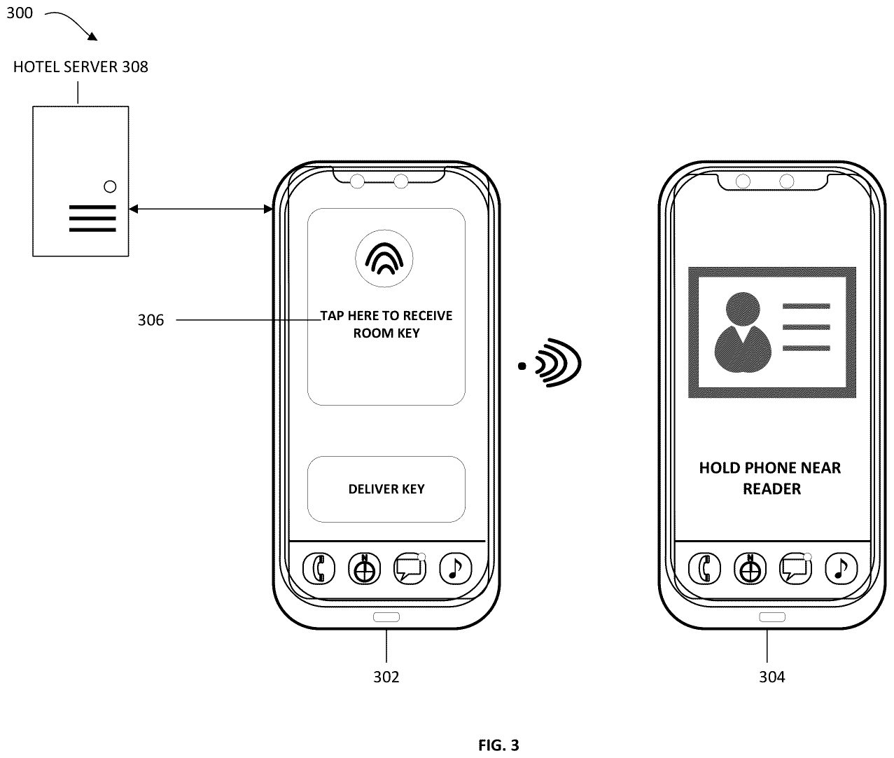

FIG. 3 is an illustration 300 of an example process for reader initiated provisioning, according to one or more embodiments. In particular, FIG. 3 can relate to provisioning an asset on a user device. A reader device 302 and a user device 304 are illustrated, which can be the same as the reader device and the user device of FIGS. 1 and 2. In response to verifying a user's identity, the reader device 302 can display a provisioning prompt 306 asking whether to provision an asset. As illustrated, the provisioning prompt 306 can ask whether to provision a hotel room key. The provisioning prompt 306 can be displayed on a touch screen and require a manual touch to initialize provisioning the digital asset. It should be appreciated that this manual inputs for the processes described herein can be entered by a user. For example, in instances that the reader device 302 can be a self-help kiosk, a user can touch the touch screen of the reader device 302 to initialize provisioning the digital asset onto the user device 304. The manual inputs can also be entered by an employee of the third party managing the reader device 302. For example, the reader device can be a smart phone of a third party employee or a point of sale system. In these instances, the third party employee may manually enter the input into the touch screen of the reader device 302.

In response to receiving a manual input against the provisioning prompt 306, the reader device 302 can communicate with a third party server. As illustrated, the third party server can be a hotel server 308, but as indicated above, the described process can apply to a variety of third parties and not just hotel or hospitality related third parties. The hotel server 308 can provision a digital asset (e.g., digital hotel room key) for the user. In some instances, the hotel server 308 has provisioned key after the user reserved a room, and in other instances, the hotel server 308 provisions a digital key in response to identification verification. The digital asset can manage rights to third party assets, including who can access the third party assets, a time frame for accessing the assets, and a manner by which the assets can be accessed. In the hotel context, a digital key can manage who can access a hotel room and facilities, what times the hotel room and facilities can be accessed, and that a room or amenities can only be accessed through a digital lock. In some instances, the digital asset may be considered a digital access asset (e.g., when it is configured to be used for accessing something).

The digital assets can be information that a third party mechanism can use to provide a user access to a third party asset. The hotel server 308 can provision the digital asset to include information to permit a third party device (e.g., hotel room door) to authenticate another device. For example, the hotel server 308 can provision the digital asset for a public key infrastructure (PKI) protocol for device authentication. The digital asset can include a unique identifier associated with the user. The digital asset can further be configured to include information that can be exchanged by the user device 304 and another device based on a short range transmission protocol, such as NFC or Bluetooth. For example, a digital hotel can be formatted for use with a proximity-based technology, such as an NFC enabled hotel door lock.

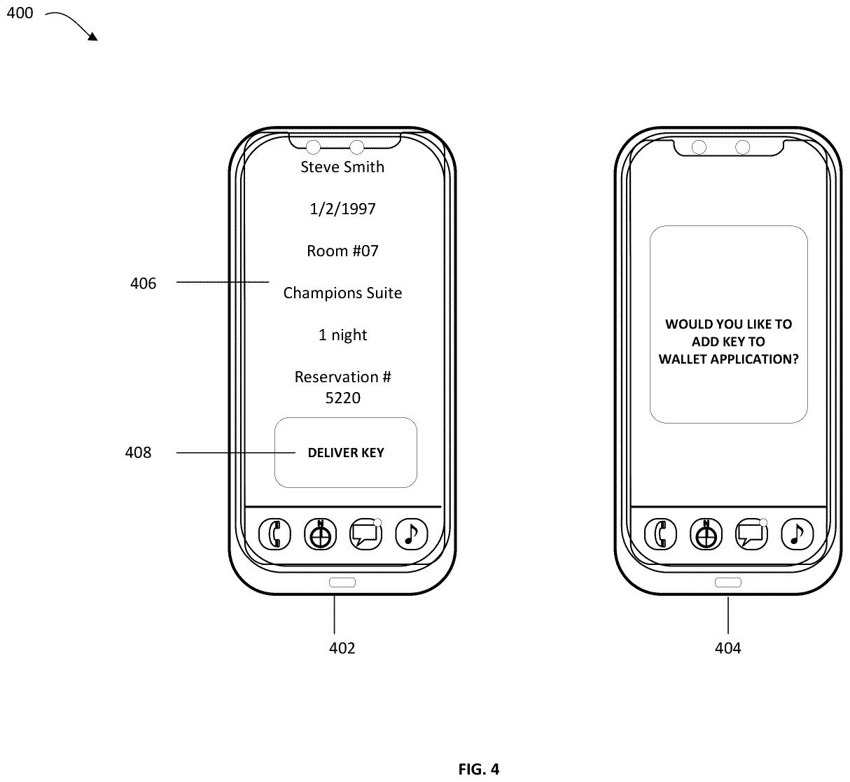

FIG. 4 is an illustration 400 of an example process for reader initiated provisioning, according to one or more embodiments. In particular, FIG. 4 can relate to provisioning an asset on a user device. A reader device 402 and a user device 404 are illustrated, which can be the same as the reader device and the user device of FIGS. 1-3. In response, to receiving the digital asset from a third party server, the reader device 402 can display user information 406. The user information 406 can include information that a user can use to verify that the third party has correctly identified the user. For example, in the hotel context, the user information 406 can include the user's name, room number, length of stay and other relevant information. The user information 406 can prevent from displaying private information, such as credit card number, passwords, private keys, public keys, and other information that should not be displayed in a public space, such as a hotel lobby. The user can view the information and verify that the user can be the same as the individual identified on the reader device 402.

The reader device 402 can further include a delivery prompt 408 for providing the reader device 402 permission to provision the user device 404 with the digital asset. A third party server can create a digital asset for the user, and transmit the digital asset to the reader device 402, but the reader device 402 can still need permission to provision the user device 404 with the digital asset. As described above, either the user (e.g., hotel guest) or third party employee (e.g., hotel staff) can manually touch the delivery prompt 408 on the touch screen of the reader device 402. In response to a manually input, the reader device 402 can transmit the digital asset to the user device 404.

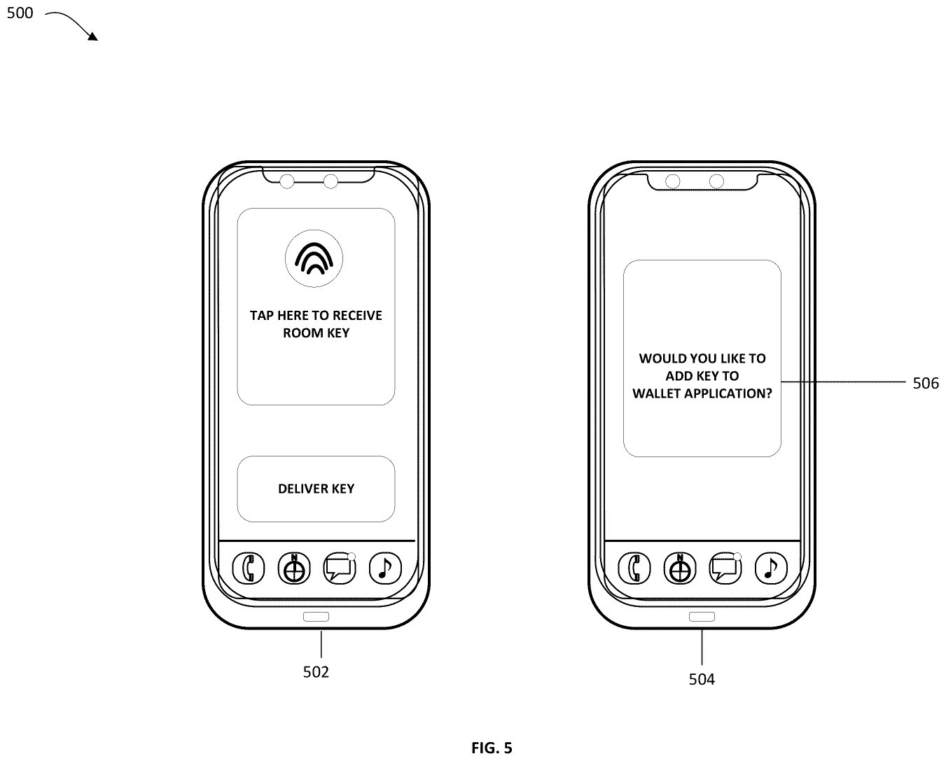

FIG. 5 is an illustration 500 of an example process for reader initiated provisioning, according to one or more embodiments. In particular, FIG. 5 can relate to provisioning an asset on a user device. A reader device 502 and a user device 504 are illustrated, which can be the same as the reader device and the user device of FIGS. 1-4. In response to receiving the digital asset from the reader device 502, the user device 404 can display a wallet application prompt 506. A wallet application (e.g., Apple Wallet®, Google Pay® can be an application for storing and organizing financial information (credit card information, bank account information), tickets, passes, coupons, and executing transactions using the application. The user can enter a manual input into a touch screen of the user device 504 to initiate downloading the digital asset onto the wallet application. On having ordinary skill in the art will appreciate that user device 404 have been provisioned with the digital asset without a third party application. In other words, it was not necessary for the user to have a third party application downloaded on the user device 504 to verify identity, request a digital asset, and have that digital asset provisioned on the user device 504. Further even if the user had the third party application on the user device, the steps herein can be performed by the user's devices identity service, a verification API, and the wallet application without the use of the third party application.

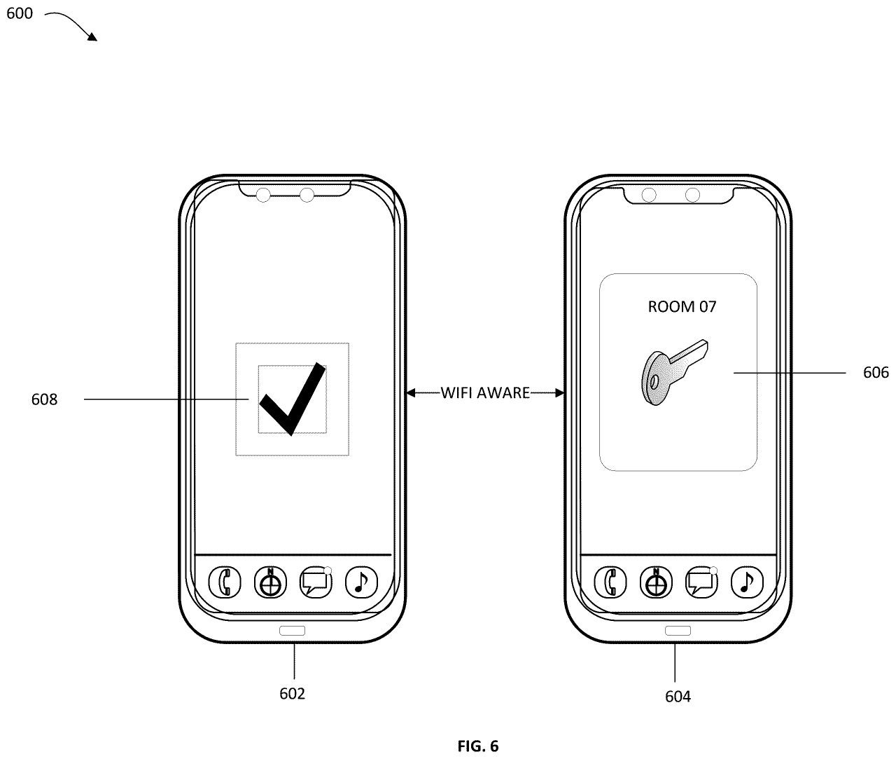

FIG. 6 is an illustration 600 of an example process for reader initiated provisioning, according to one or more embodiments. In particular, FIG. 6 can relate to provisioning an asset on a user device. A reader device 602 and a user device 604 are illustrated, which can be the same as the reader device and the user device of FIGS. 1-5. In response to downloading the digital asset onto the wallet application, the user device 504 can display a digital asset icon 606. The digital asset icon 606 can be a visual representation of the digital asset. For example, in the hotel context, the digital asset icon 606 can be a room number and a key. In addition, the reader device 602 can display a completion icon to visually notify the user that the process is complete. The completion icon 608 can be any of visual symbol and/or textual character(s). As illustrated, the completion icon 608 can be a check mark. The user can see the completion icon 608 displayed on the reader device 602 and understand that the provisioning process is over.

The provisioning process is not limited to provisioning digital keys. In some embodiments, the provisioning process can be applied to other digital assets such as tickets for an event, such as a concert, sporting event, play, convention, or other event.

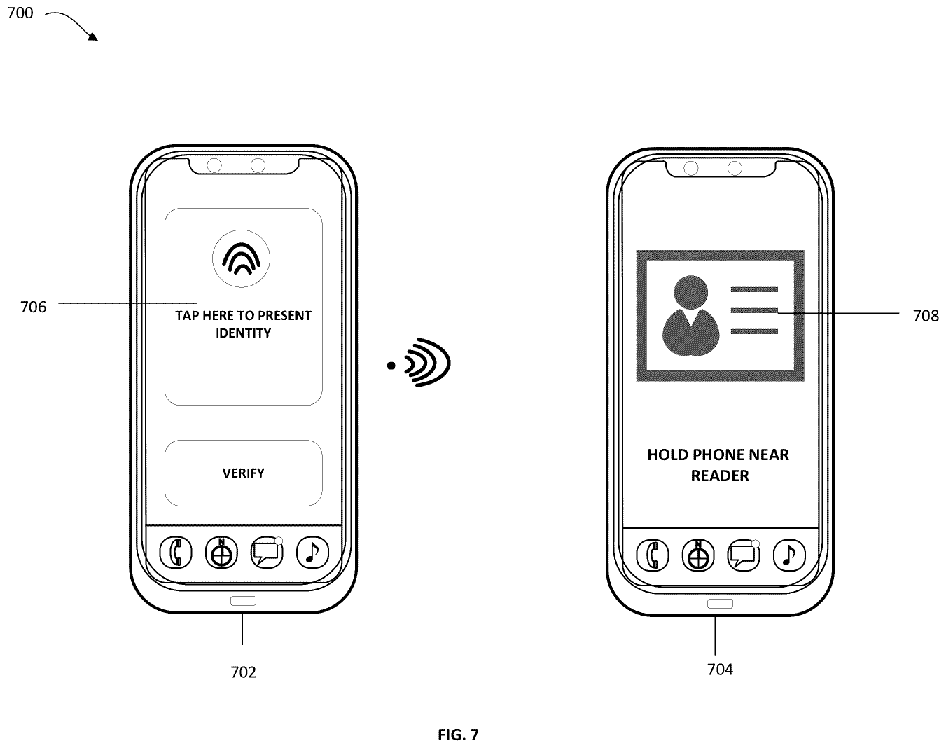

FIG. 7 is an illustration 700 of an example process for reader initiated provisioning, according to one or more embodiments. A reader device 702 and a user device 704 are illustrated. The user device 704 can be the same user device as in FIGS. 1-6 or a different user device. The reader device 702 can device managed by a same or different third party than the third party of the FIGS. 1-6. The reader device 702 can be the same reader device of the FIGS. 1-6 or a different reader device. As illustrated, the reader device 702 has been arranged to provision a digital ticket for the user.

A user can approach the reader device 702 with their user device 704 while both devices are powered on. For example, the user can approach a ticketing kiosk at a concert venue. When the reader device 702 and the 104 become within a threshold range (e.g., four inches) of each other, the devices can establish a secure connection with each other, in which sensitive data can be encrypted for in flight transmission.

In response to establishing a secure connection, the reader device 702 can display presentation prompt 706. In addition, the user device 704 can display a user identity 708 and instructions to hold the user device 704 near the reader device 702, or vice versa. For example, the user identity 708 can be presented via an identity service or application configured to provide a user identity to reader device. The user can take the user device 704 and tap the display side against the reader device 702. The reader device 702 can include a verification API for receiving identification data and verifying the identity of the user's device's owner. For example, the user can have previously purchased a ticket through an online service (e.g., concert venue ticketing or secondary market ticketing). During the purchase process, the user can have provided his or her name, image, address, credit card number and other identifying information. This information can be stored at a third party server (e.g., venue server) that can be in operable connection with the reader device 702. The verification API can collect identification information from the user device 704 to verify the identity through the third party server. For example, the name, credit card information, and address of the user entered at the time of reservation can be compared to the personal identification information presented through the user device 704 identity service or application.

In some embodiments, the reader device 702 and the user device 704 can be WiFi aware, also known as NAN, that can enable reader device 702 and the user device 704 to discover each other and connect directly without each other without another type of connectivity between them. Once the reader device 702 and the user device 704 have discovered each other the devices can create a bi-directional WiFi Aware network connection without an access point (AP) (e.g., router).

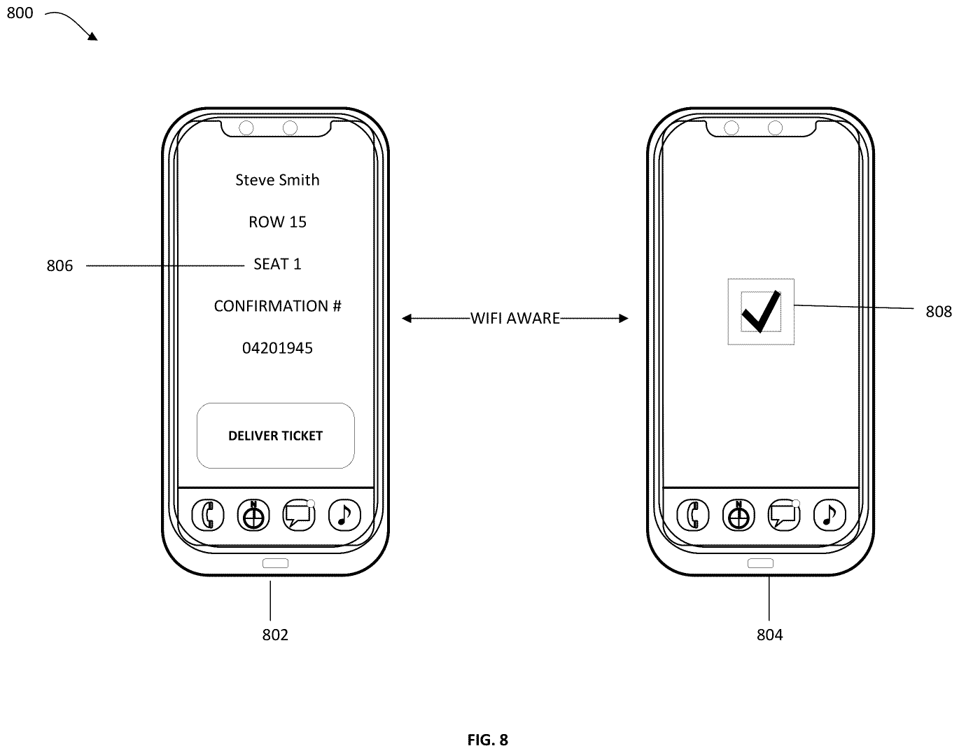

FIG. 8 is an illustration 800 of an example process for reader initiated provisioning, according to one or more embodiments. In particular, FIG. 8 can relate to verifying an identity of a user of a user device. A reader device 802 and a user device 804 are illustrated. The user device 804 can be the same user device as in FIGS. 1-7 or a different user device. The reader device 802 can device managed by a same or different third party than the third party of the FIGS. 1-6. The reader device 802 can be the same reader device of the FIGS. 1-7 or a different reader device.

In response to verifying the identity, the reader device 802 can display user identification information 806. The user identification information 806 can include a name and seating assignment. The user can see the user identification information 806 and verify that the correct user is identified. In response to transmitting the user information to the reader device 802, the user device 804 can display a visual icon 808 for notifying the user that the user information has been transferred. As illustrated, the visual icon 808 can be a check mark, but can be any number of icons that convey that the identification information transfer was successful. In this sense, the user of the user device 804 can see that the identification information transfer was successful. In the event that the identification verification transfer was unsuccessful another visual icon could be displayed, such as an “x” to indicate that the transfer was unsuccessful. In the event the identification information transfer is unsuccessful, the user can retry the transfer. The user device 804 and the reader device 802 can remain in a WiFi Aware state while the reader device 802 is presenting the visual icon 808.

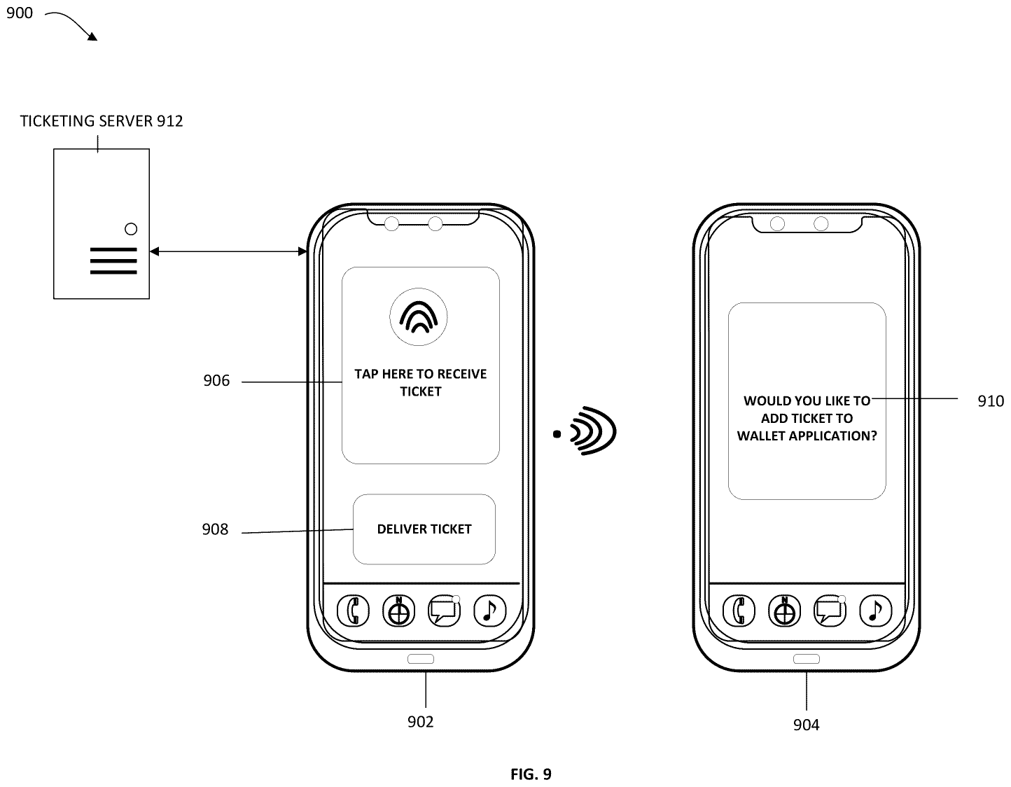

FIG. 9 is an illustration 900 of an example process for reader initiated provisioning, according to one or more embodiments. In particular, FIG. 9 can relate to provisioning an asset on a user device. A reader device 902 and a user device 904 are illustrated. The user device 904 can be the same user device as in FIGS. 1-8 or a different user device. The reader device 902 can device managed by a same or different third party than the third party of the FIGS. 1-8. The reader device 902 can be the same reader device of the FIGS. 1-8 or a different reader device.

In response to verifying a user's identity, the reader device 902 can display a provisioning prompt 906 asking whether to provision an asset. As illustrated, the provisioning prompt 906 can ask “tap here to receive ticket”. The provisioning prompt 906 can be displayed on a touch screen and require a manual touch to initialize provisioning the digital asset. It should be appreciated that this manual inputs for the processes described herein can be entered by a user. For example, in instances that the reader device 902 can be a self-help kiosk at a concert venue, a user can touch the touch screen of the reader device 902 to initialize provisioning the digital asset (e.g., event ticket) onto the user device 904. The manual inputs can also be entered by an employee of the third party managing the reader device 902. For example, the reader device can be a smart phone of a third party employee at a will call booth. In these instances, the third party employee may manually enter the input into the touch screen of the reader device 902.

In response to receiving a manual input against the provisioning prompt 906, the reader device 902 can communicate with a third party server. As illustrated, the third party server can be a ticketing server 912. The ticketing server 912 can provision a digital asset (e.g., event ticket) for the user. In some instances, the ticketing server 912 can provision the ticket after the user purchased the ticket, and in other instances, the ticketing server 912 can provisions a ticket in response to identification verification. The digital asset can manage rights to third party assets, including who can access the third party assets, a time frame for accessing the assets, and a manner by which the assets can be accessed. In the event context, a digital ticket can manage who can access the event venue, event times that the venue can be accessed, and amenities that can only be accessed through the ticket (e.g., backstage passes, beverage and food coupons).

The digital asset can include a unique identifier associated with the user. The digital asset can further be configured to include information that can be exchanged by the user device 304 and another device based on a short range transmission protocol, such as NFC or Bluetooth. For example, a digital hotel can be formatted for use with a proximity-based technology, such as a gate reader when entering the venue.

The reader device 902 can further include a delivery prompt 908 for providing the reader device 902 permission to provision the user device 904 with the digital asset. A third party server (e.g., ticketing server 912) can create a digital asset for the user, transmit the digital asset to the reader device 902, but the reader device 902 can still need permission to provision the user device 904 with the digital asset. As described above, either the user (e.g., concert goer) or third party employee (e.g., concert venue staff) can manually touch the delivery prompt 908 on the touch screen of the reader device 902. In response to a manually input, the reader device 902 can transmit the digital asset to the user device 904.

In response to receiving the digital asset from the reader device 902, the user device 904 can display a wallet application prompt 910. The user can enter a manual input into a touch screen of the user device 904 to initiate downloading the digital asset onto the wallet application. On having ordinary skill in the art will appreciate that user device 904 have been provisioned with the digital asset without a third party application (e.g., concert venue application, secondary market application). In other words, it was not necessary for the user to have a third party application downloaded on the user device 904 to verify identity, request a digital asset, and have that digital asset provisioned on the user device 904. Further even if the user had the third party application on the user device, the steps herein can be performed by the user's devices identity service, a verification API, and the wallet application without the use of the third party application.

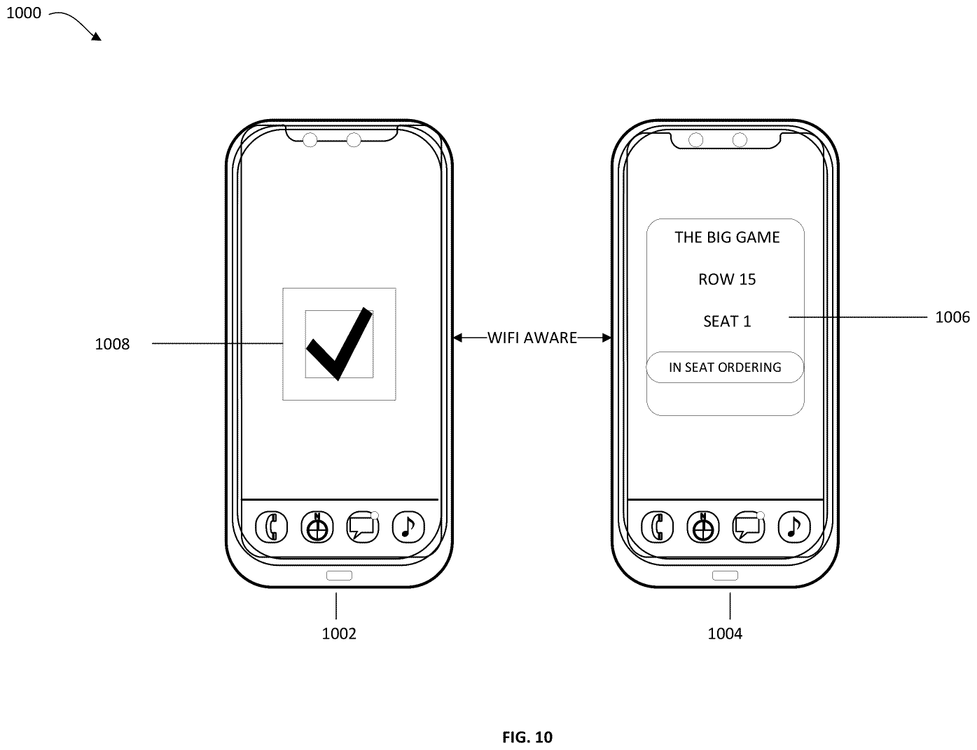

FIG. 10 is an illustration 1000 of an example process for reader initiated provisioning, according to one or more embodiments. In particular, FIG. 10 can relate to provisioning an asset on a user device. A reader device 1002 and a user device 1004 are illustrated, which can be the same as the reader device and the user device of FIGS. 1-9. In response to downloading the digital asset onto the wallet application, the user device 1004 can display a digital asset icon 1006. The digital asset icon 1006 can be a visual representation of the digital asset. For example, in the venue context, the digital asset icon 1006 can be an event title, a row number, and seat number. In addition, the reader device 1002 can display a completion icon to visually notify the user that the process is complete. The completion icon 1008 can be any of visual symbol and/or textual character(s). As illustrated, the completion icon 1008 can be a check mark. The user can see the completion icon 1008 displayed on the reader device 1002 and understand that the provisioning process is over. The user can use their user device 1004 to present to a gate reader and enter the event venue.

In some instances, the digital asset provisioned by a reader device onto a user device can be information. For example, the digital asset can be sensitive information such as electronic health records.

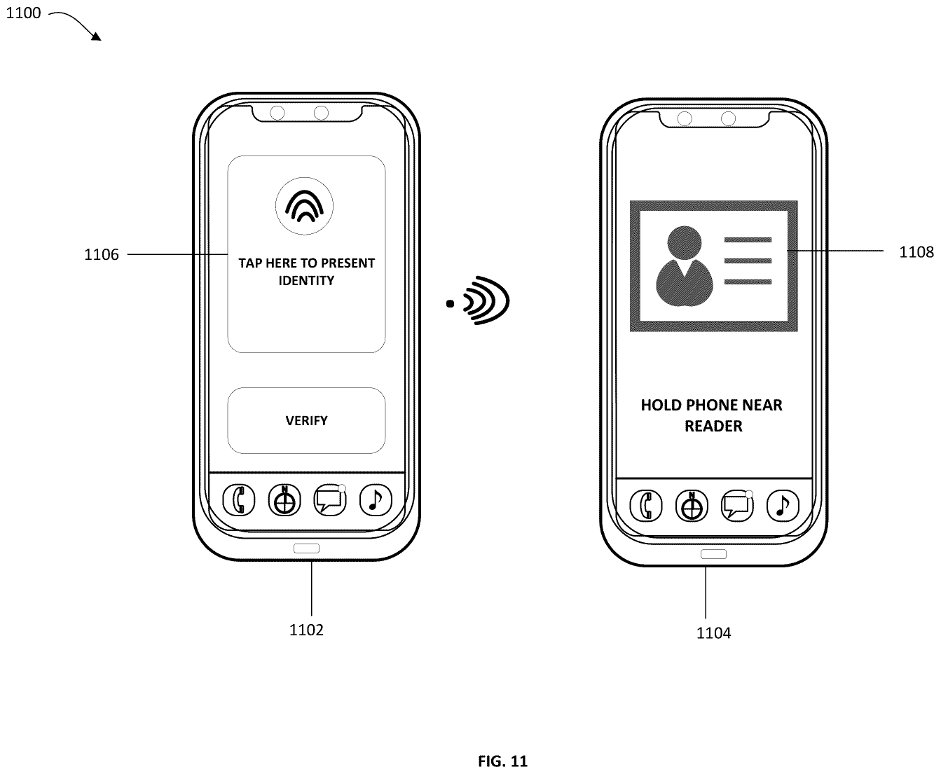

FIG. 11 is an illustration 1100 of an example process for reader initiated provisioning, according to one or more embodiments. A reader device 1102 and a user device 1104 are illustrated. The user device 1104 can be the same user device as in FIGS. 1-10 or a different user device. The reader device 1102 can be managed by a same or different third party device than the third party of the FIGS. 1-10. The reader device 1102 can be the same reader device of the FIGS. 1-10 or a different reader device. As illustrated, the reader device 1102 has been arranged to provision a digital ticket for the user.

A user can approach the reader device 1102 with their user device 1104 while both devices are powered on. For example, the user can approach a health kiosk at a hospital or doctor's office. When the reader device 1102 and the 1104 become within a threshold range (e.g., four inches) of each other, the devices can establish a secure connection with each other, in which sensitive data can be encrypted for in flight transmission.

In response to establishing a secure connection, the reader device 1102 can display presentation prompt 1106. In addition, the user device 1104 can display a user identity 1108 and instructions to hold the user device 1104 near the reader device 1102, or vice versa. For example, the user identity 1108 can be presented via an identity service or application configured to provide a user identity to a reader device. The user can take the user device 1104 and tap the display side against the reader device 1102. The reader device 1102 can include a verification API for receiving identification data and verifying the identity of the user's device's owner. For example, the user can have previously seen a health care provider. During the sign in process, the user can have provided his or her name, image, address, credit card number, and other identifying information. This information can be stored at a third party server (e.g., an electronic health record server (EHR)) that can be in operable connection with the reader device 1102. The verification API can collect identification information from the user device 1104 to verify the identity through the third party server. For example, the name, credit card information, and address of the user entered at the time of reservation can be compared to the personal identification information presented through the user device 1104 identity service or application.

In some embodiments, the reader device 1102 and the user device 1104 can be WiFi aware, also known as NAN, that can enable reader device 1102 and the user device 1104 to discover each other and connect directly without each other without another type of connectivity between them. Once the reader device 1102 and the user device 1104 have discovered each other the devices can create a bi-directional WiFi Aware network connection without an access point (AP) (e.g., router).

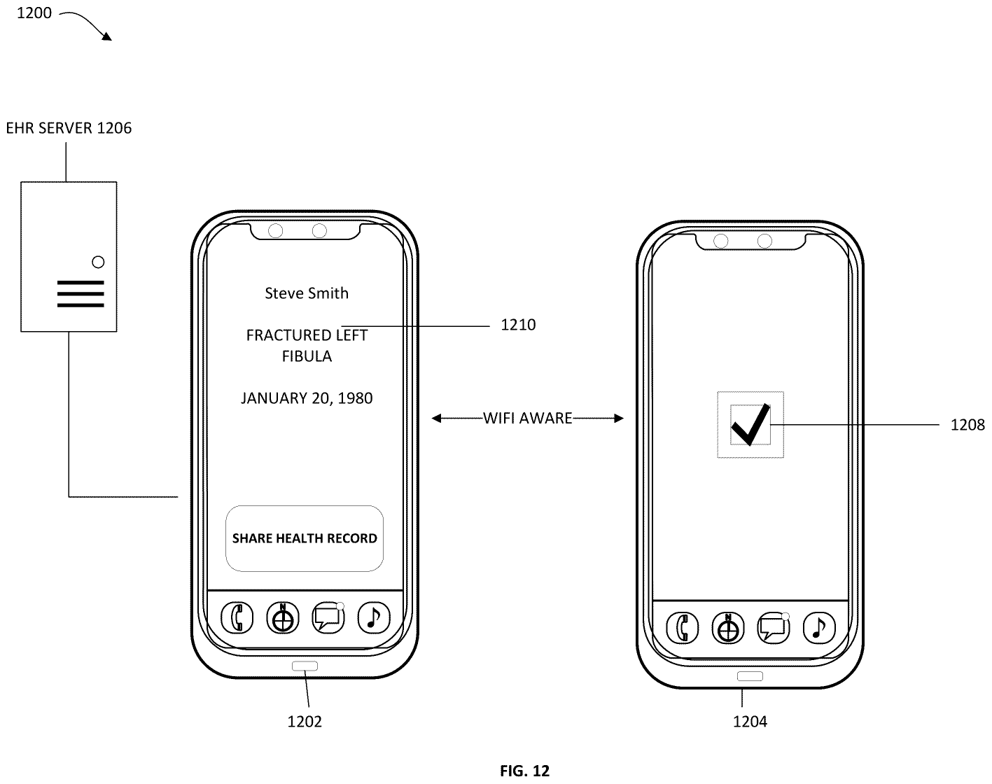

FIG. 12 is an illustration 1200 of an example process for reader initiated provisioning, according to one or more embodiments. In particular, FIG. 12 can relate to verifying an identity of a user of a user device. A reader device 1202 and a user device 1204 are illustrated. The user device 1204 can be the same user device as in FIGS. 1-11 or a different user device. The reader device 1202 can device managed by a same or different third party than the third party of the FIGS. 1-11. The reader device 1202 can be the same reader device of the FIGS. 1-11 or a different reader device.

In response to verifying the identity, the reader device 1202 can display a user electronic health records 1210 retrieved from a EHR server 1206. The electronic health records 1210 can include a name and health information. The user can see the user identification and verify that the correct user can be identified. In response to transmitting the user information to the reader device 1202, the user device 1204 can display a visual icon 1208 for notifying the user that the identity information has been transferred. As illustrated, the visual icon 1208 can be a check mark, but can be any number of icons that convey that the identification information transfer was successful. In this sense, the user of the user device 1204 can see that the identification information transfer was successful. In the event that the identification verification transfer was unsuccessful another visual icon could be displayed, such as an “x” to indicate that the transfer was unsuccessful. In the event the identification information transfer is unsuccessful, the user can retry the transfer. The user device 1204 and the reader device 1202 can remain in a WiFi Aware state while the reader device 1202 is presenting the visual icon 1208.

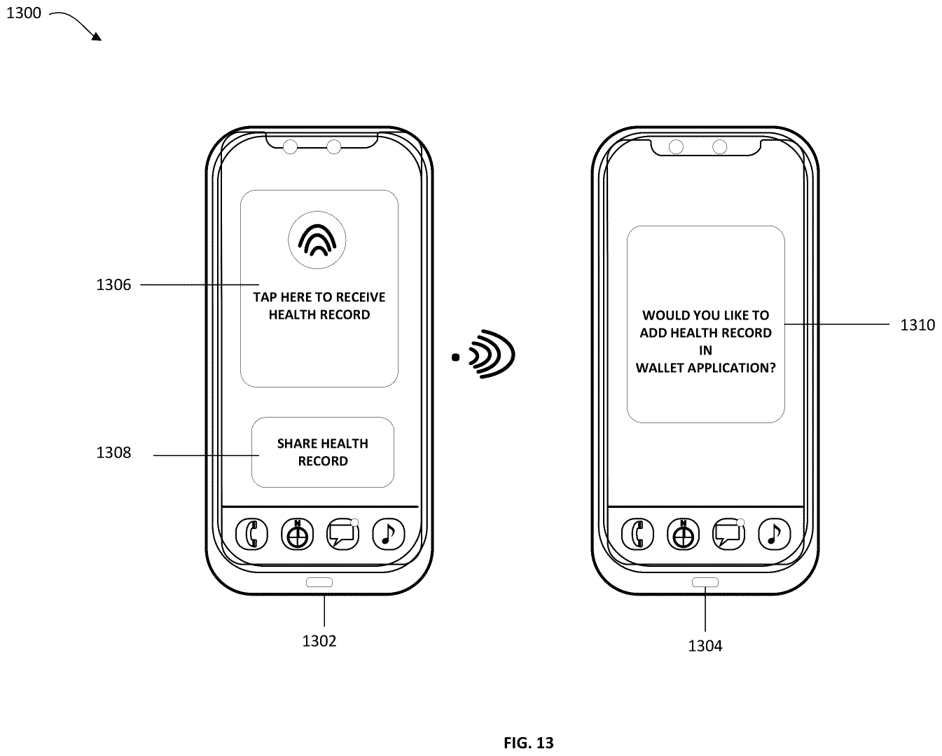

FIG. 13 is an illustration 1300 of an example process for reader initiated provisioning, according to one or more embodiments. In particular, FIG. 13 can relate provisioning an asset on a user device. A reader device 1302 and a user device 1304 are illustrated. The user device 1304 can be the same user device as in FIGS. 1-12 or a different user device. The reader device 1302 can device managed by a same or different third party than the third party of the FIGS. 1-12. The reader device 1302 can be the same reader device of the FIGS. 1-12 or a different reader device.

In response to verifying a user's identity, the reader device 1302 can display a provisioning prompt 1306 asking whether to provision an asset. As illustrated, the provisioning prompt 1306 can ask “tap here to receive health record”. The provisioning prompt 1306 can be displayed on a touch screen and require a manual touch to initialize provisioning the digital asset. It should be appreciated that this manual inputs for the processes described herein can be entered by a user. For example, in instances where the reader device 1302 can be a self-help kiosk at a doctor's office, a user can touch the touch screen of the reader device 1302 to initialize provisioning the digital asset onto the user device 1304. The manual inputs can also be entered by an employee of the third party managing the reader device 1302. For example, the reader device can be a smart phone of a third party employee at a nurse's station. In these instances, the third party employee may manually enter the input into the touch screen of the reader device 1302.

In response to receiving a manual input against the provisioning prompt 1306, the reader device 1302 can communicate with a third party server. As illustrated, the third party server can be an EHR server 1206 of FIG. 12. The EHR server can provision a digital asset (e.g., EHR) for the user. In some instances, the EHR server can provision the EHR after the user made a doctor's appointment, and in other instances, the EHR server can provision the EHR in response to identification verification to the doctor's office. The digital asset can include a unique identifier associated with the user. The digital asset can further be configured to include information that can be exchanged by the user device 1304 and another device based on a short range transmission protocol, such as NFC or Bluetooth. For example, a digital hotel can be formatted for use with a proximity-based technology, such as a kiosk in a doctor's office or pharmacy.

The reader device 1302 can further include a delivery prompt 1308 for providing the reader device 1302 permission to provision the user device 1304 with the digital asset. A third party server (e.g., EHR server) can create a digital asset for the user, transmit the digital asset to the reader device 1302, but the reader device 1302 can still need permission to provision the user device 1304 with the digital asset. As described above, either the user (e.g., patient) or third party employee (e.g., medical staff) can manually touch the delivery prompt 1308 on the touch screen of the reader device 1302. In response to a manually input, the reader device 1302 can transmit the digital asset to the user device 1304.

In response to receiving the digital asset from the reader device 1302, the user device 1304 can display a wallet application prompt 1310. The user can enter a manual input into a touch screen of the user device 1304 to initiate downloading the digital asset onto the wallet application. On having ordinary skill in the art will appreciate that user device 1304 have been provisioned with the digital asset without a third party application (e.g., EHR). In other words, it was not necessary for the user to have a third party application downloaded on the user device 1304 to verify identity, request a digital asset, and have that digital asset provisioned on the user device 1304. Further even if the user had the third party application on the user device, the steps herein can be performed by the user's devices identity service, a verification API, and the wallet application without the use of the third party application.

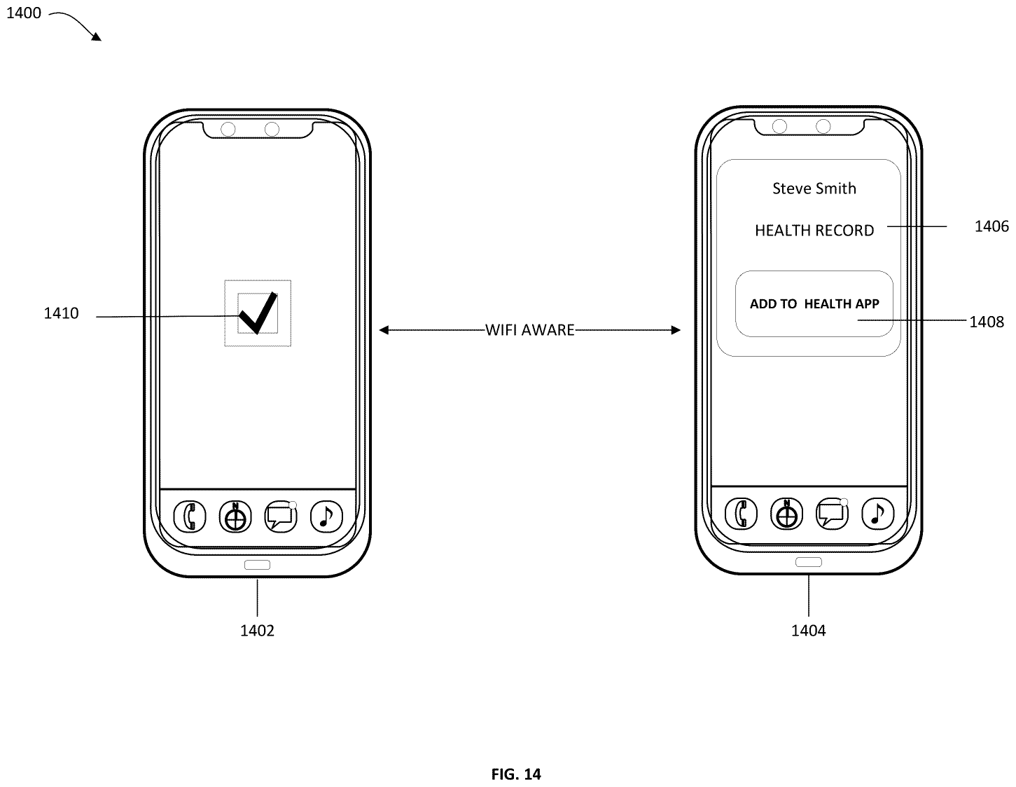

FIG. 14 is an illustration 1400 of an example process for reader initiated provisioning, according to one or more embodiments. In particular, FIG. 14 can relate to provisioning an asset on a user device. A reader device 1402 and a user device 1404 are illustrated, which can be the same as the reader device and the user device of FIGS. 1-13.

In response to downloading the digital asset onto the wallet application, the user device 1404 can display a digital asset icon 1406. The digital asset icon 1406 can be a visual representation of the digital asset. In addition, in some instances, a digital asset can be associated with another application on the user device 1404. In these instances, the user device 1404 can send a secondary prompt 1408, as to whether the user wants to add the digital asset to the other application. For example, whether the user wants to add HER to a health application. In addition, the reader device 1002 can display a completion icon to visually notify the user that the process is complete. The completion icon 1410 can be any of visual symbol and/or textual character(s). As illustrated, the completion icon 1410 can be a check mark. The user can see the completion icon 1410 displayed on the reader device 1402 and understand that the provisioning process is over. The user can use their user device 1404 to present to a gate reader and enter the event venue.

Reader initiated provisioning enables devices to read, but also provision secure element (SE) passes, ancillary data, and also App clip code to a wallet application. The use cases include, access passes, boarding passing, digital receipts, car rentals, health data, tickets, coupons, loyalty, transit, SE backed pass and pass not SE back, executable code, redemption bundle (bearer token), and app clips. An app clip can be a portion of an application that performs a specific task. App clips offer application like functionality in the absence of having the entire application downloaded onto a device.

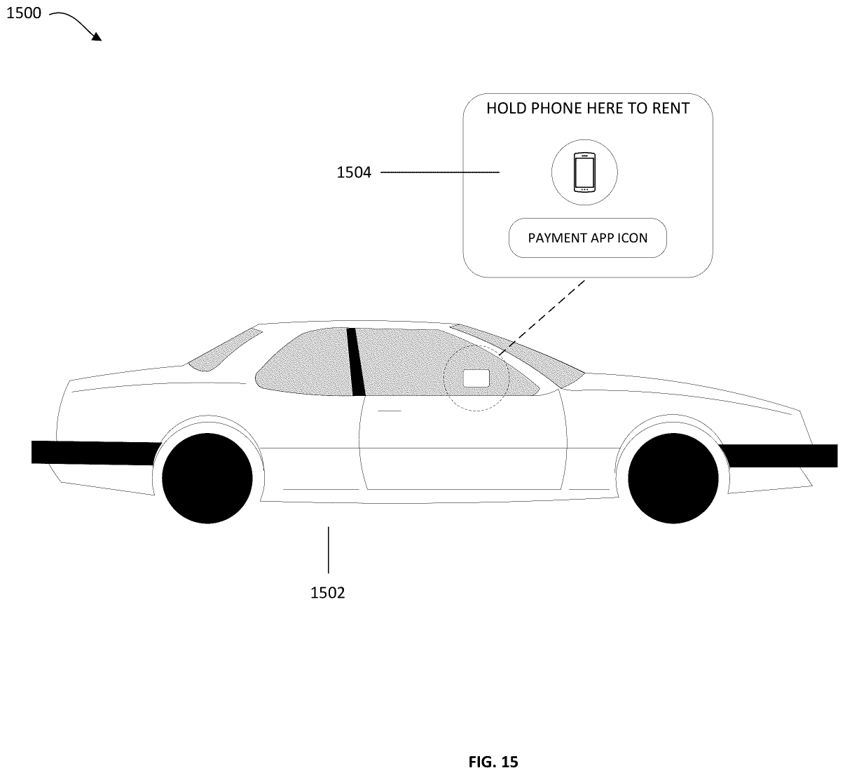

FIG. 15 is an illustration of a car with reader initiated provisioning functionality, according to one or more embodiment. A car 1502 (e.g., rental car) can include information (e.g., on a sticker) 1504 with a direction to hold a phone to rent the car. The sticker 1504 can be placed anywhere on the car where it can be accessible by a potential renter. In some embodiments, the sticker 1504 includes an NFC tag for initiating an app clip for the rental car company.

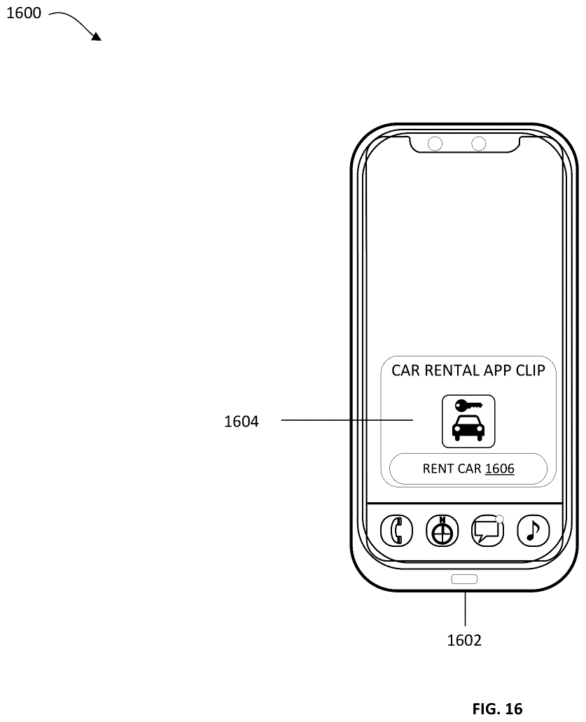

FIG. 16 is an illustration 1600 of an example process for reader initiated provisioning, according to one or more embodiments. A user device 1602 that can be a reader device is illustrated, the user device 1602 which can be the same as the reader device and the user device of FIGS. 1-15. Based on a communication with the sticker (e.g., NFC tag), the user device 1602 can display an app clip 1604 for a third party (e.g., rental car service). The app clip 1604 can include a prompt 1606 for obtaining a product or service. In the car rental context, this can be for renting a car.

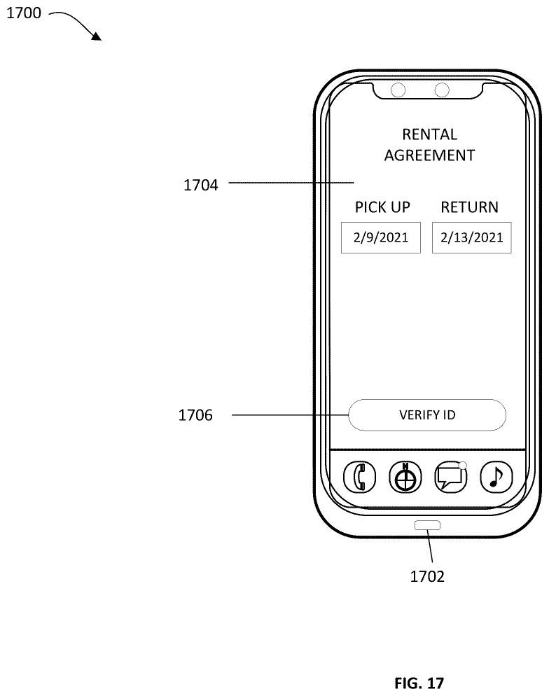

FIG. 17 is an illustration 1700 of an example process for reader initiated provisioning, according to one or more embodiments. A user device 1702 that can be a reader device is illustrated, the user device 1702 which can be the same as the reader device and the user device of FIGS. 1-16. The app clip can display general terms 1704 for a product or service. The app clip can further include a verification prompt 1706 for verifying a user identification. The user can verify identification as described above.

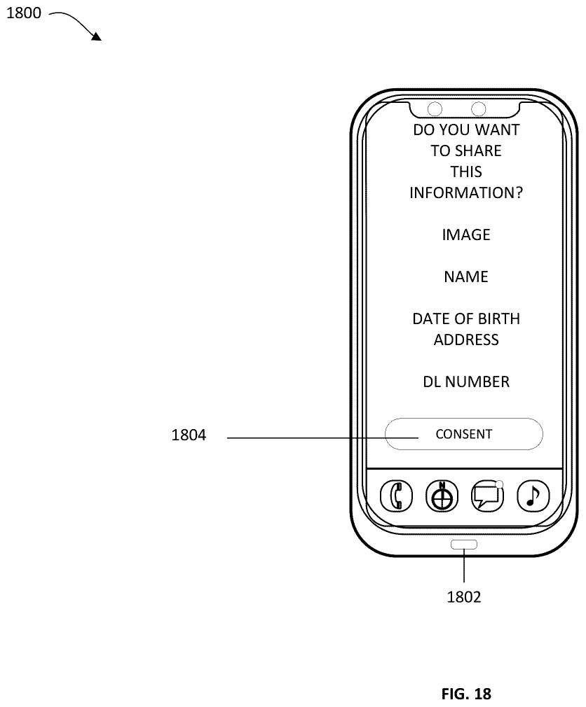

FIG. 18 is an illustration 1800 of an example process for reader initiated provisioning, according to one or more embodiments. A user device 1802 that can be a reader device is illustrated, the user device 1802 which can be the same as the reader device and the user device of FIGS. 1-17. In response to entering a manual input to verify identification, the user device can display a consent prompt 1804 requesting whether the user wants one or more pieces of information to be transmitted through the app clip to the third party. The user can select one or more items of personal information using the touchscreen of the user device 1802 and select the consent prompt 1804. It should be appreciated that the consent prompt can be incorporated into any of the here described embodiments.

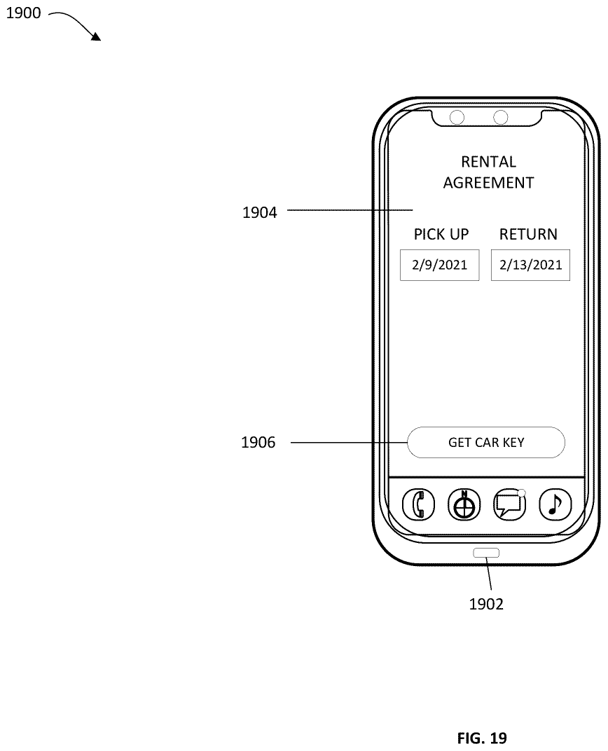

FIG. 19 is an illustration 1900 of an example process for reader initiated provisioning, according to one or more embodiments. A user device 1902 that can be a reader device is illustrated, the user device 1902 which can be the same as the reader device and the user device of FIGS. 1-18. In response to verifying the user's identity, the app clip can display an agreement 1904. The app clip can further include a provisioning prompt 1906 asking if the user wants a digital asset provisioned to the user device 1902. The user can manually select the provisioning prompt 1906, and the app clip can retrieve a digital asset (e.g., car rental key) from a third party server (e.g., car rental server). The app clip can further provision the user device 1902 with the digital asset.

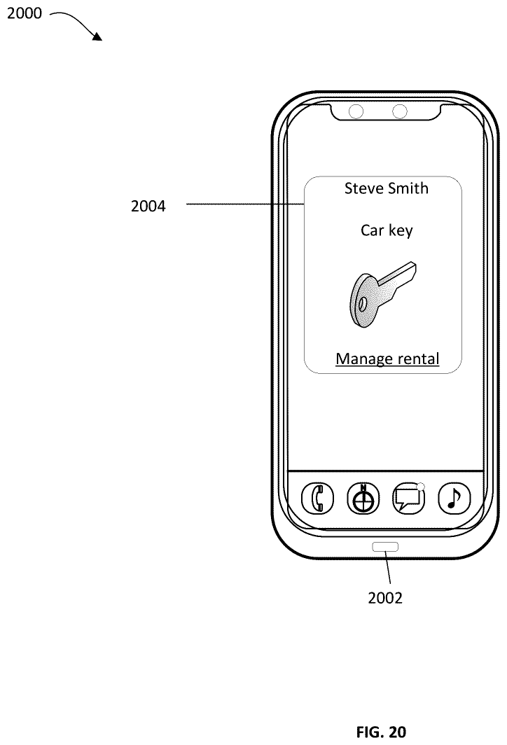

FIG. 20 is an illustration 2000 of an example process for reader initiated provisioning, according to one or more embodiments. A user device 2002 that can be a reader device is illustrated, the user device 2002 which can be the same as the reader device and the user device of FIGS. 1-19. In response to having the digital asset provisioned on the user device 2002, a visual icon 2004 of the digital asset can be displayed. As illustrated, a digital key to enter and operate a rental car is displayed. For other products and services, the visual icon 2004 can match those products and services.

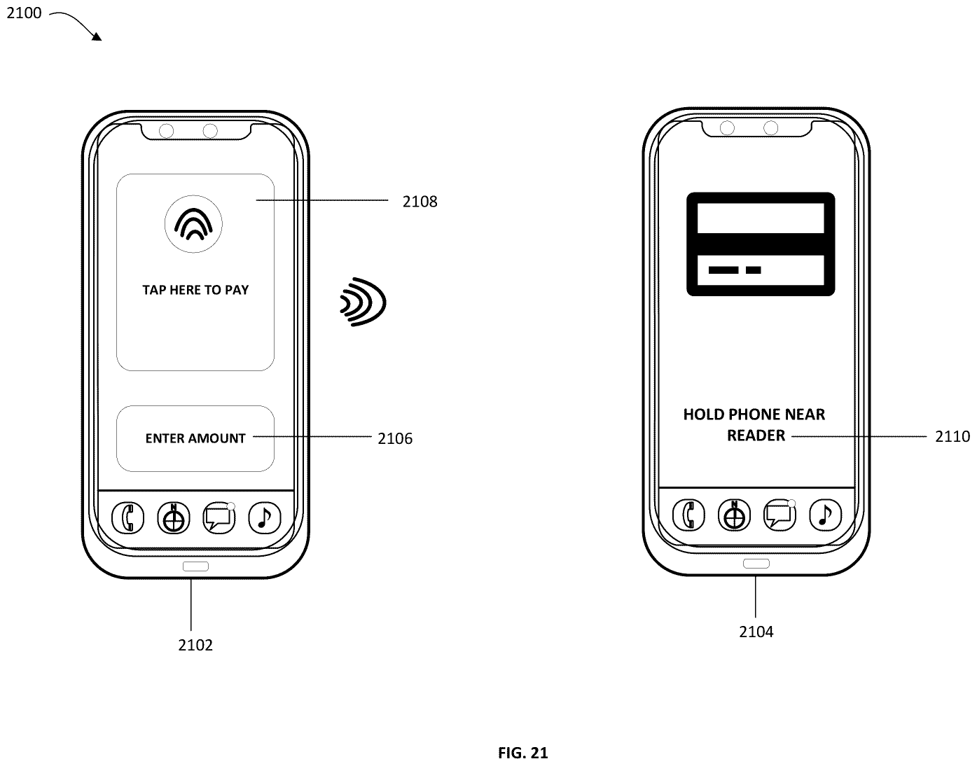

FIG. 21 is an illustration 2100 of an example process for reader initiated provisioning, according to one or more embodiments. A reader device 2102 and a user device 2104 are illustrated. A reader device can be any device (e.g., smartphone, laptop, kiosk) capable of executing a wireless protocol to communicate with the user device 2104. For example, the reader device 2102 can include an integrated circuit (e.g., near field communication (NFC), radio frequency identification (RFID), Bluetooth) for wirelessly communicating with the user device 2104 over a short range. The reader device can be a device that a third party has arranged to provision an asset to a user through the user device 2104. As illustrated, the reader device 2102 has been arranged to provision a receipt for the user. It should be appreciated that the illustrated method can be used for a variety of third party services that provision an asset on a user device, and without necessarily having a third party application executing on the device.

The reader device 2102 can include pane 2106 to permit a user to enter an amount to pay. The reader device can further include a notice 2108 to “tap here to pay”. A user can approach the reader device 2102 with their user device 2104 while both devices are powered on. In the instances that the reader device 2102 and the user device 2104 become within a threshold range (e.g., four inches) of each other, the devices can establish a secure connection with each other, in which sensitive data can be encrypted for in flight transmission. For example, both devices can be active NFC devices that operate in a peer-to-peer-mode, in which the devices are active when transmitting and passive when receiving.

The user device 2104 can directional notice 2110 to direct the user to hold the phone near the reader device. The user device 2104 can further include a payment application to effectuate a payment through the device.

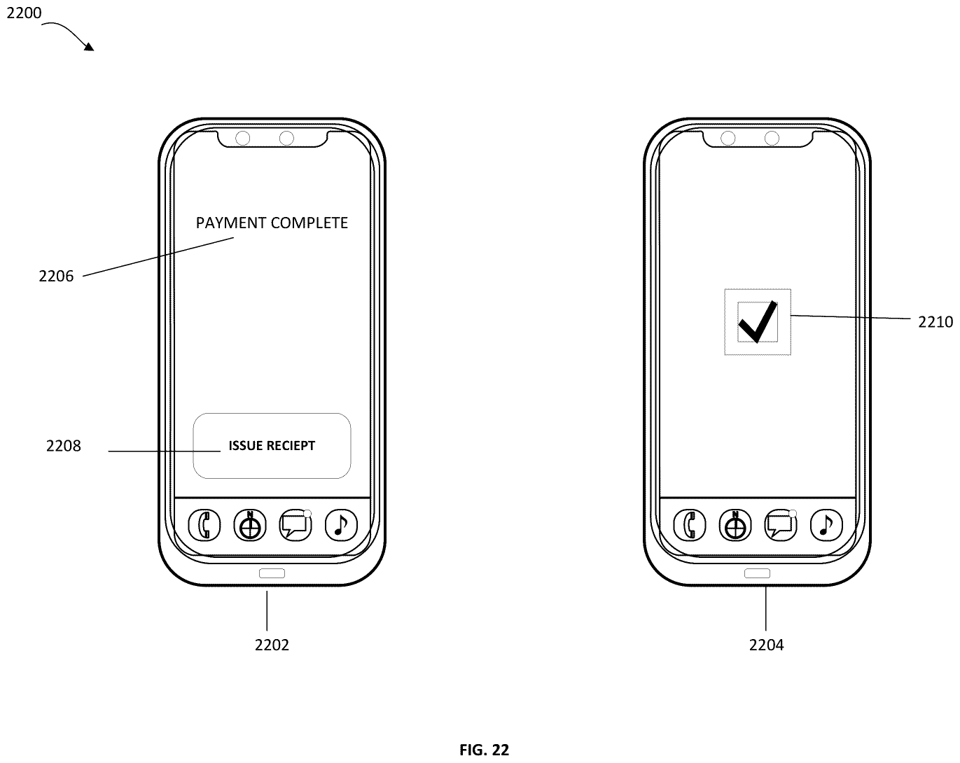

FIG. 22 is an illustration 2200 of an example process for reader initiated provisioning, according to one or more embodiments. A reader device 2202 and a user device 2204 are illustrated. The reader device 2202 can display a completion notification 2206 that a transaction has completed. The reader device 2202 can further display a provisioning prompt 2208 for requesting to provision a receipt onto the user device 2204. The user device 2204 can include a completion icon 2210 to indicate that a transaction from the user to the third party is complete.

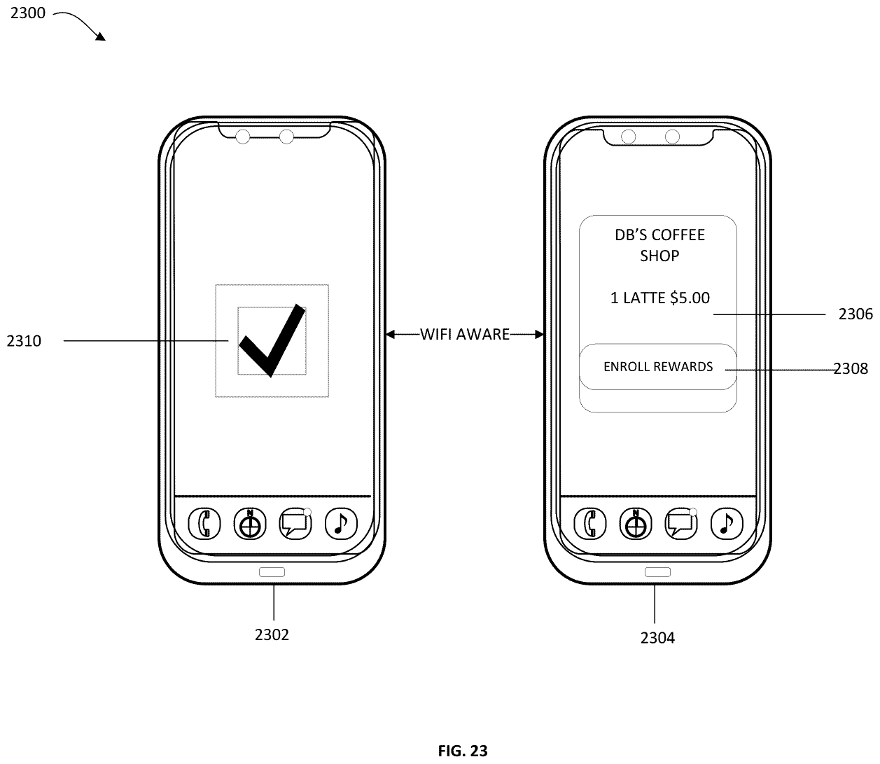

FIG. 23 is an illustration 2300 of an example process for reader initiated provisioning, according to one or more embodiments. A reader device 2302 and a user device 2304 are illustrated. The reader device 2302 can display a completion icon 2310 that a transaction has completed. The user device 2304 can further display a receipt 2306. The user device 2304 can include a rewards prompt 2308 for accessing a rewards program for the third party.

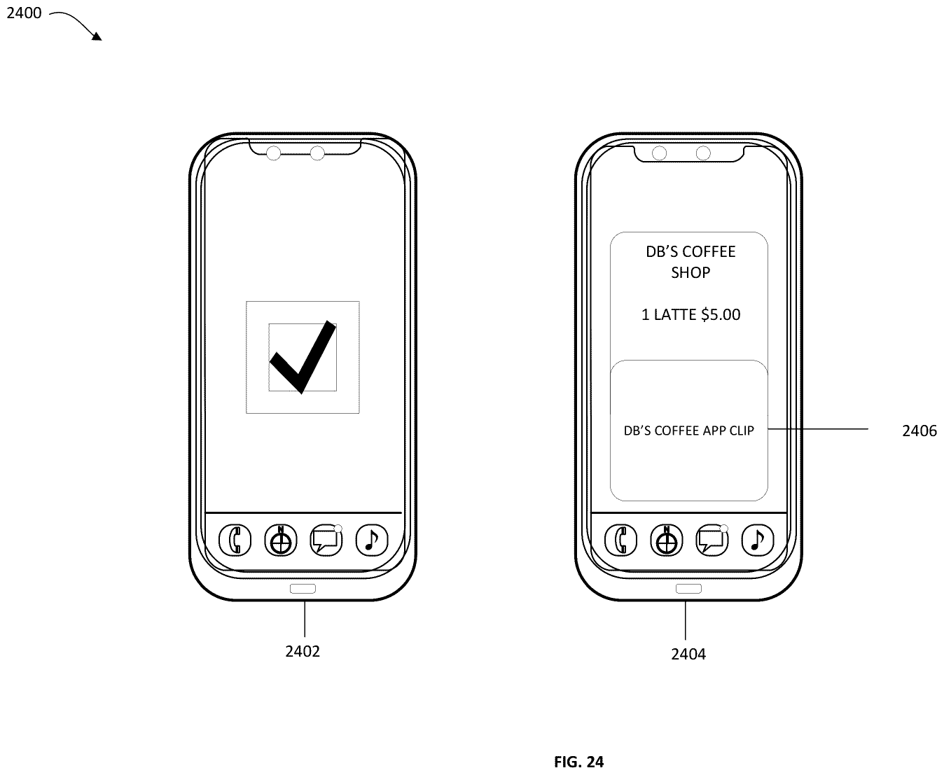

FIG. 24 is an illustration 2400 of an example process for reader initiated provisioning, according to one or more embodiments. A reader device 2402 and a user device 2404 are illustrated. In response to selecting the rewards prompt 2308 of FIG. 23, the user device 2404 can display an app clip for the third party. The user can then access the third party through the app clip

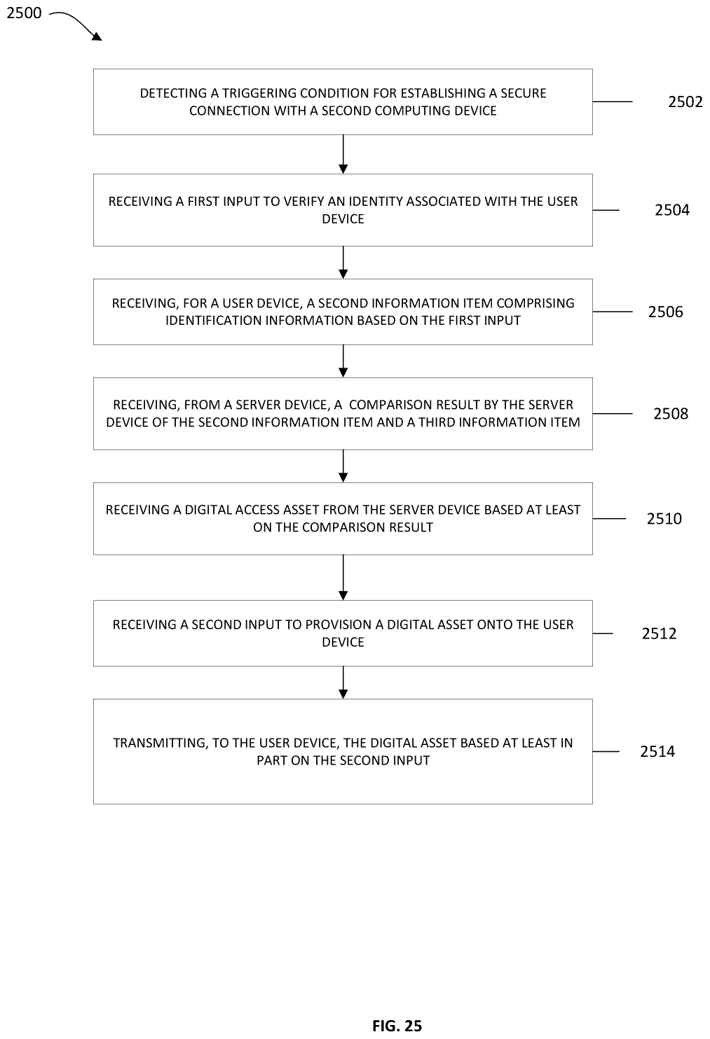

FIG. 25 is a process flow for read initiated provisioning, according to one or more embodiments. While the operations of process 2500 are described as being performed by generic computers, it should be understood that any suitable device (e.g., a reader device, a responder device) may be used to perform one or more operations of these processes. Process 2500 (described below) is illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes

At 2502, the method can include a first computing device detecting a triggering condition for establishing a secure condition with a second computing device. The condition can include the first computing device detecting the second computing device within a threshold distance of the first computing device. The triggering condition can also be receiving a manual input to establish the secure connection. The triggering condition can also be detecting a visual marker (e.g., a QR code, barcode, or other visual marker).

At 2504, the method can include receiving, from the user device, a first information item comprising identification information based at least in part on the first input.

At 2506, the method can include the reader device receiving, from a server device, a comparison result based at least in part on the server device comparing the first information item and a second information item comprising a subset of the identification information.

At 2508, the method can include the reader device receiving a digital access asset from the server device based at least in part on the comparison result.

At 2510, the method can include the reader device receiving a second input to provision a digital asset onto the user device.

At 2512 the method can include the reader device transmitting to the user device, the digital asset based at least in part on the second input.

Thus, although specific embodiments have been described, it will be appreciated that embodiments may include all modifications and equivalents within the scope of the following claims.

As described above, one aspect of the present technology is the gathering and use of data available from specific and legitimate sources to improve the provisioning of digital assets to a user device. The present disclosure contemplates that in some instances, this gathered data may include personal information data that uniquely identifies or may be used to identify a specific person. Such personal information data may include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, may be used to the benefit of users. For example, the personal information data may be used to authenticate a user identity. Further, other uses for personal information data that benefit the user are also contemplated by the present disclosure.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities may subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements may be provided to prevent or block access to such personal information data. For example, such as in the case digital asset provisioning, the present technology may be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon using an app clip that their personal information data will be accessed and then reminded again just before personal information data is accessed by the app.

Illustrative techniques for using a computing device to delegate authority to generate a token from an owner to a sharing platform and provisioning the token by the sharing platform. Some or all of these techniques may, but need not, be implemented at least partially by as those shown at least in FIGS. 1-25 above. While many of the embodiments are described above with reference to computing devices and user devices, it should be understood that other types of computing devices may be suitable to perform the techniques disclosed herein. Further, in the foregoing description, various non-limiting examples were described. For purposes of explanation, specific configurations and details are set forth in order to provide a thorough understanding of the examples. However, it should also be apparent to one skilled in the art that the examples may be practiced without the specific details. Furthermore, well-known features were sometimes omitted or simplified in order not to obscure the example being described.

The various embodiments further can be implemented in a wide variety of operating environments, which in some cases can include one or more user computers, computing devices or processing devices that can be used to operate any of a number of applications. User or client devices can include any of a number of general-purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a network server, the network server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more applications that may be implemented as one or more scripts or programs written in any programming language, such as Java®, C, C # or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable storage media for containing code, or portions of code, can include any appropriate media known or used in the art such as, but not limited to, volatile and non-volatile, removable and non-removable media implemented in any method or technology for storage of information such as computer-readable instructions, data structures, program modules or other data, including RAM, ROM, Electrically Erasable Programmable Read-Only Memory (EEPROM), flash memory or other memory technology, CD-ROM, DVD or other optical storage, magnetic cassettes, magnetic tape, magnetic disk storage or other magnetic storage devices or any other medium that can be used to store the desired information and that can be accessed by the a system device. Based at least in part on the disclosure and teachings provided herein, a person of ordinary skill in the art will appreciate other ways and/or methods to implement the various embodiments. However, computer-readable storage media does not include transitory media such as carrier waves or the like.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a,” “an,” and “the,” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based at least in part on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A method, comprising:
detecting, by a first computing device, a triggering condition for establishing a secure connection with a second computing device;
receiving, by the first computing device, a first input to verify an identity associated with the second computing device based at least in part on detecting the triggering condition;
receiving, by the first computing device and from the second computing device, a first information item comprising identification information based at least in part on the first input;
receiving, by the first computing device and from a server device, a comparison result based at least in part on the server device comparing the first information item and a second information item comprising a subset of the identification information;
receiving, by the first computing device, a digital access asset from the server device based at least in part on the comparison result;
receiving, by the first computing device, a second input to provision the digital access asset onto the second computing device; and
transmitting, by first computing device and to the second computing device, the digital access asset based at least in part on the second input.

2. The method of claim 1, wherein the method further comprises:
receiving a third input to transmit the digital access asset to the second computing device; and
transmitting the digital access asset to the second computing device based at least in part on the third input.

3. The method of claim 1, further comprising verifying the identity by transmitting the first information item to the server device, wherein the server device is configured to verify the identity based at least in part on the first information item and the second information item.

4. The method of claim 1, wherein the method further comprises displaying the second information item based at least in part on the verification.

5. The method of claim 1, wherein the method further comprises displaying the digital access asset based at least in part on the second input.

6. The method of claim 1, wherein the triggering condition is based at least in part on a threshold proximity.

7. The method of claim 1, wherein the method further comprises establishing the secure connection using a near field communication (NFC) protocol.

8. A first computing device, comprising:
one or more processors; and
one or more computer readable media including instructions that, when executed, cause the one or more processors to perform operations comprising:
detecting a triggering condition for establishing a secure connection with a second computing device;
receiving a first input to verify an identity associated with the second computing device based at least in part on detecting the triggering condition;
receiving from the second computing device, a first information item comprising identification information based at least in part on the first input;
receiving, from a server device, a comparison result based at least in part on the server device comparing the first information item and a second information item comprising a subset of the identification information;
receiving a digital access asset from a server device based at least in part on the comparison result;
receiving a second input to provision the digital access asset onto the second computing device; and
transmitting, to the second computing device, the digital access asset to the second computing device based at least in part on the second input.

9. The first computing device of claim 8, wherein the instructions that, when executed, further cause the one or more processors to perform operations comprising:
receiving a third input to transmit the digital access asset to the second computing device; and
transmitting the digital access asset to the second computing device based at least in part on the third input.

10. The first computing device of claim 8, wherein the instructions that, when executed, further cause the one or more processors to perform operations comprising verifying the identity by transmitting the first information item to the server device, wherein the server device is configured to verify the identity based at least in part on the first information item and the second information item.

11. The first computing device of claim 8, wherein the instructions that, when executed, further cause the one or more processors to perform operations comprising displaying the second information item based at least in part on the verification.

12. The first computing device of claim 8, wherein the instructions that, when executed, further cause the one or more processors to perform operations comprising displaying the digital access asset based at least in part on the second input.

13. The first computing device of claim 8, wherein the triggering condition is based at least in part on a threshold proximity.

14. The first computing device of claim 8, wherein the instructions that, when executed by the one or more processors, further cause the processor to perform operations comprising establishing the secure connection using a near field communication (NFC) protocol.

15. One or more non-transitory computer-readable media including stored thereon a sequence of instructions that, when executed, causes one or more processors to perform operations comprising:
detecting a triggering condition for establishing a secure connection with a second computing device;
receiving a first input to verify an identity associated with the second computing device;
receiving, from the second computing device, a first information item comprising identification information based at least in part on the first input;
receiving, from a server device, a comparison result based at least in part on the server device comparing the first information item and a second information item comprising a subset of the identification information;
receiving digital access asset from a server device based at least in part on the comparison result;
receiving a second input to provision the digital access asset onto the second computing device; and
transmitting, to the second computing device, the digital access asset to the second computing device based at least in part on the second input.

16. The non-transitory computer-readable media of claim 15, wherein the instructions that, when executed, further cause the one or more processors to perform operations comprising:
receiving a third input to transmit the digital access asset to the second computing device; and
transmitting the digital access asset to the second computing device based at least in part on the third input.

17. The non-transitory computer-readable media of claim 15, wherein the instructions that, when executed, further cause the one or more processors to perform operations comprising verifying the identity by transmitting the first information item to the server device, wherein the server device is configured to verify the identity based at least in part on the first information item and the second information item.

18. The non-transitory computer-readable media of claim 15, wherein the instructions that, when executed, further cause the one or more processors to perform operations comprising displaying the second information item based at least in part on the verification.

19. The non-transitory computer-readable media of claim 15, wherein the instructions that, when executed, further cause the one or more processors to perform operations comprising displaying the digital access asset based at least in part on the second input.

20. The non-transitory computer-readable media of claim 15, wherein the triggering condition is based at least in part on a threshold proximity.
